(19) United States
(12) Patent Application Publication
(10) Pub. No.: US 2003/0110248 A1
(43) Pub. Date: Jun. 12, 2003

(54) Automated service support of software distribution in a distributed computer network

(76) Inventor: Scott D. Ritche, Centennial, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 09/779,147

(22) Filed: Feb. 8, 2001

(51) Int. Cl. G06F 15/173; H02H 3/05

(52) U.S. Cl. 709/224; 714/4

(57) ABSTRACT

A computer system, and associated method, with a tool for processing error alerts issued during distribution of application packages to network client devices. The tool validates error alerts to filter out erroneous alerts and parses error alerts to obtain a subset of information useful for tracking each error alert and for producing maintenance job tickets. Threshold limits for each type of error are utilized to further filter the error alerts by updating counts for each type of error and comparing these counts to the threshold limits. Once a threshold limit is exceeded, the tool performs further verification to determine whether a job ticket should be issued including performing a look up for the affected network device in an outage notice file. A job ticket is created which includes verified information and the ticket is then transmitted to the maintenance center determined responsible for servicing the affected network device.

### BACKGROUND OF THE INVENTION

1. Field of the Invention

The present invention relates, in general, to automated software or package distribution in a distributed computer network, and, more particularly, to a system and method for processing error messages to automatically manage the creation, content, and transmittal of electronic service requests or service job tickets used to initiate maintenance or repair efforts for specific computer or data communication devices in the distributed computer network.

2. Relevant Background

Distributed computer networks with de-centralized software environments are increasingly popular designs for network computing. In such distributed computer networks, a copy of a software program (i.e., an application package such as Netscape™, Staroffice™, and the like) is distributed over a data communications network by a master or central network device for installation on client network devices that request or require the particular application package. The master network device may be a server or a computer device or system that maintains current versions and copies of applications run within the distributed computer network. When an application is updated with a new version or with patches to correct identified bugs, the master server functions to distribute updated application packages through one or more intermediate servers and over the communications network to the appropriate client network devices, i.e., the devices utilizing the updated application. The client network device may be an end user device, such as a personal computer, computer workstation, or any electronic computing device, or be an end user server that shares the application with a smaller, more manageable number of the end user devices within the distributed computer network. In this manner, the distributed computer network provides stand-alone functionality at the end user device and makes it more likely that a single failure within the network will not cripple or shut down the entire network (as is often the case in a centralized environment when the central server fails).

While these distributed computer networks provide many operating advantages, servicing and maintaining client network devices during software installation and operation are often complicated and costly tasks. The networks often include large numbers of client network devices, such as intermediate servers, end user servers, and end user devices upon which applications must be installed and which must be serviced when installation and/or operation problems occur. In addition to the large quantity of devices that must be serviced, the client network devices may be located nearly anywhere as the use of the Internet as the distribution path enables application packages to be rapidly and easily distributed worldwide. The master server is typically located in a geographic location that is remote from the client network devices, which further complicates servicing of the devices as repair personnel need to be deployed at or near the location of the failing device such as from a regional or onsite service center. Efforts have been made to facilitate effective application package distribution and installation in numerous and remotely-located client network devices (see, for example, U.S. Pat. No. 6,031,533 to Peddada et al.). However, existing software distribution systems do not meet the industry need for effective monitoring and servicing of client network devices during and after the distribution of application packages.

Generally, during operation of a distributed computer network, a master server executing a distribution tool operates to distribute an application package over the communications network through intermediate servers to a number of—remote end user servers and end user devices. The receiving devices may be listed as entries in a network distribution database which includes a delivery address (e.g., domain and/or other information suiting the particular communications network), a client node network name, package usage data (e.g., which packages are used or served from that client network device), and other useful package distribution information. A distribution list is created for a particular application, and the distribution tool uses the list as it transmits copies of the application package to the appropriate end user servers and end user devices for installation.

If delivery fails, installation fails, or if other problems occur, the affected or upstream client network devices transmit error messages back to the distribution tool. In a relatively large network, the distribution tool may receive hundreds, thousands, or more error messages upon the distribution of a single application package. In many distributed computer networks, a service desk device or service center (e.g., a computer system or a server operated by one or more operators that form a service team) is provided to respond to software installation and other network operating problems. In these networks, the distribution tool gathers all of the error messages and transmits them to the service desk as error alerts. For example, the distribution tool may send e-mail messages corresponding to each error message to the e-mail address of the service desk to act on the faults, errors, and failures in the network. The operator(s) of the service desk must then manually process each e-mail to determine if service of the network or client network devices is required, which service group is responsible for the affected device, and what information is required by the service department to locate the device and address the problem. If deemed appropriate by the operator, the service desk operator manually creates (by filling in appropriate fields and the like) and transmits an electronic service request, i.e., service job ticket, to a selected service group to initiate service. The receiving service group then processes the job ticket to assign appropriate personnel to fix the software or hardware problem in the network device.

Problems and inefficiencies are created by the use of the existing service management methods. The manual processing of the error alerts from the distribution system can rapidly overwhelm the service desk resulting in service delays or require large numbers of personnel to timely respond resulting in increased service costs. The manual processing of the error alerts also results in errors as the human operator may incorrectly fill out a job ticket with insufficient and/or inaccurate information making repair difficult or impossible. The job ticket may also be accidentally assigned to the wrong service group.

Additionally, numerous job tickets may be issued based on a single network problem. For example, a problem with an Internet connection or service provider may result in numerous error messages being transmitted to the distribution tool, which in turn issues error alerts to the service desk, because distribution and installation failed at all client network devices downstream from the true problem. Due to the large number of error alerts being received at the service desk, an operator would have great difficulty in tracking alerts and/or identifying specific problems, and in this example, would most likely transmit a job ticket for each device for which installation failed. The service group may respond to the job ticket by wasting time inspecting the device referenced in the job ticket only to find no operating problem because the true problem occurred upstream within the network.

The service group may further be bogged down as it receives multiple job tickets for the same device that must be assigned and/or cleared (e.g., a single client network device may issue more than one error message upon a failure to install an application package). The number of error messages and error alerts with corresponding job tickets may increase rapidly if the distribution tool acts to retry failed transmittals and installations without filtering the error alerts it transmits to the service desk. Clearly, the existing service management techniques result in many “false” job tickets being issued that include incorrect device and failure/problem information, that request repair of a device that is not broken or offline, and that request repair or service for a device whose problems were previously addressed in another job ticket. Each false job ticket increases service costs and delays responses to true client network device problems.

Hence, there remains a need for an improved method and system for providing service support of software distribution in a distributed computer network. Such a method and system preferably would be useful within a geographically disburse network in which the central or master server is located remote from the end user servers, end user devices, and service centers. Additionally, such a method and system would reduce the cost of monitoring and assigning service requests to appropriate service centers or personnel while increasing the effectiveness of identifying particular network problems, increasing the speed at which error alerts are processed, and reducing the volume of repetitive and “false” job tickets that are created and issued.

### SUMMARY OF THE INVENTION

The present invention addresses the above discussed and additional problems by providing an automated service support system including an auto ticket tool for processing numerous error alerts issued during distribution of application packages to network client devices in a network. According to one aspect of the invention, the auto ticket tool is configured to validate each error alert to filter out erroneous or garbage-type alerts (e.g., for e-mail alerts, testing the source of the alert and checking for proper subject line). According to another aspect, the auto ticket tool parses each error alert to obtain a smaller subset of information useful for tracking the error alert and for producing a job ticket to address a verified problem. This parsed information is then stored in memory in error tracking files.

According to a significant aspect of the auto ticket tool, predetermined or user-selectable threshold limits for each type of distribution problem or error are utilized to further filter the large number of error alerts, i.e., to, typically, not issue a job ticket for every error alert to more effectively utilize service resources. In practice, the auto ticket tool updates counts for each type of problem and/or for each network device and then compares these counts to the threshold limits. Once a threshold limit is exceeded, the auto ticket tool performs further verification steps to determine whether a job ticket should be issued, and these additional verification steps may include performing a look up for the affected network device in an outage notice file and performing diagnostics on the affected network device. The auto ticket tool then is uniquely adapted to fill out or create a job ticket including verifying and correcting select information fields (e.g., device location and the like) and to transmit it (via e-mail or otherwise) to the maintenance center responsible for servicing the affected network device (and, in some embodiments, to automatically page responsible personnel).

More particularly, a method is provided for processing error alerts created in a computer network due to failures arising in distribution of a software or application package to network devices. The error alerts generally include a large amount of information related to the package distribution failure. The method includes receiving an error alert and then processing the error alert to identify from the error alert information which type of failure is announced or believed to have caused the failure. Next, an error tracking file containing tracking values for each of the failure types is updated to incrementally change the tracking value coinciding with the identified failure type. The updated tracking value is then compared with a predetermined threshold limit for the identified failure type. If the threshold limit is now exceeded, a job ticket is automatically created that based on the information in the error alert. In this regard, the method may include parsing the information in the error alert to a smaller subset for use in the job ticket.

Preferably, the method includes validating the error alert prior to updating tracking values by checking the source of the error alert and the subject of the error alert. The method typically includes transmitting the created job ticket to a recipient maintenance center responsible for the network device identified in the error alert as being affected by the failure. To insure proper selection of the recipient, the method may include retrieving network device identification information and location information from the error alert, accessing a device location listing in memory with the identification information, and if necessary, correcting the location information prior to creating the job ticket.

### BRIEF DESCRIPTION OF THE DRAWINGS

FIG. 1 illustrates a service support system with a service desk comprising an auto ticket tool and other components for automated processing of error alerts issued during software distribution to selectively and automatically create and issue job tickets to appropriate maintenance centers;

FIG. 2 is a flow diagram showing operation of the auto ticket tool of the service desk of FIG. 1 to provide the automated processing of error alerts and selective issuing of job tickets;

FIG. 3 is a flow diagram showing validation steps used as part of the process of FIG. 2 for an embodiment of the auto ticket tool used for processing e-mail error alerts; and

FIG. 4 is an exemplary record of an error alert or auto ticket file illustrating useful fields for storing tracking information and information used by the auto ticket tool in automatically creating job tickets.

### DETAILED DESCRIPTION OF THE PREFERRED EMBODIMENTS

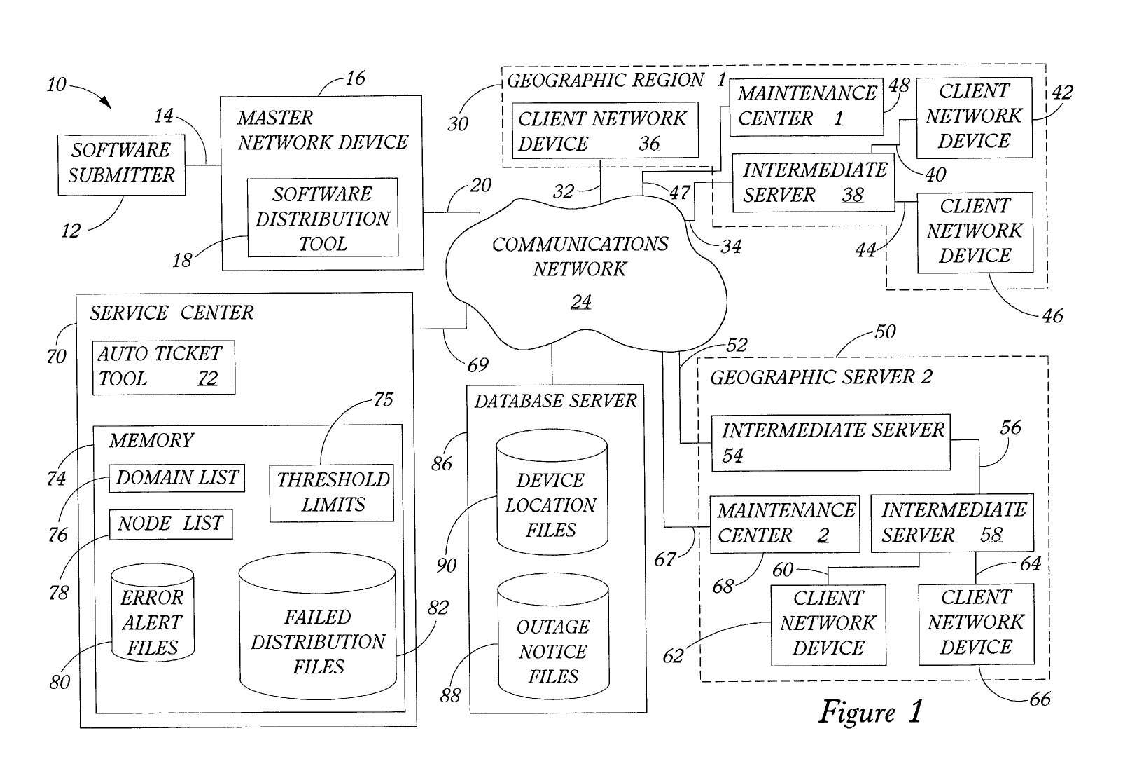

FIG. 1 illustrates one embodiment of an automated service support system 10 useful for providing automated processing of error alerts arising during software distribution throughout a computer network. In this regard, an auto ticket tool 72 is provided that is configured to, among other tasks, receive error alerts, validate the alerts, retrieve useful information from the alerts, determine when and whether a job ticket should be created, and create and distribute job tickets to appropriate maintenance facilities and personnel with verified accurate information. The functions and operation of the auto ticket tool 72 are described in a client/server, de-centralized computer network environment with error alerts and job tickets being transmitted in the form of e-mails. While this is a highly useful implementation of the invention, those skilled in the computer and networking arts will readily appreciate that the auto ticket tool 72 and its features are transferable to many data communication systems that utilize numerous and varied data transfer techniques. These variations to the exemplary automated service support system 10 are considered within the breadth of the following disclosure and claims.

As illustrated, the service support system 10 includes a software submitter 12 in communication with a master network device 16 via data communication link 14. The software submitter 12 provides application packages to the master network device 16 for distribution to select client network devices or end users. In the following discussion, network devices, such as software submitter 12 and master network device 16, will be described in relation to their function rather than as particular electronic devices and computer architectures. To practice the invention, the computer devices and network devices may be any devices useful for providing the described functions, including well-known data processing and communication devices and systems such as personal computers with processing, memory, and input/output components. Many of the network devices may be server devices configured to maintain and then distribute software applications over a data communications network. The communication links, such as link 14, may be any suitable data communication link, wired or wireless, for transferring digital data between two electronic devices (e.g., a LAN, a WAN, an Intranet, the Internet, and the like). In a preferred embodiment, data is communicated in digital format following standard protocols, such as TCP/IP, but this is not a limitation of the invention as data may even be transferred on storage mediums between the devices or in print out form for later manual or electronic entry on a particular device.

With the application package, the software submitter 12 generally will provide a distribution list (although the master network device 16 can maintain distribution lists or receive requests from end user devices) indicating which devices within the network 10 are to receive the package. The master network device 16, e.g., a server, includes a software distribution tool 18 that is configured to distribute the application package to each of the client network or end user devices (e.g., end user servers, computer work stations, personal computers, and the like) on the distribution list. Configuration and operation of the software distribution tool 18 is discussed in further detail in U.S. Pat. No. 6,031,533 to Peddada et al., which is incorporated herein by reference. Additionally, the software distribution tool 18 may be configured to receive error alerts (e.g., e-mail messages) from network devices detailing distribution, installation, and other problems arising from the distribution of the application package.

To distribute the application package and receive error alerts, the master network device 16 is connected via communication link 20 to a communications network 24, e.g., the Internet. The service support system 10 may readily be utilized in very large computer networks with servers and clients in many geographic areas. This is illustrated in FIG. 1 with the use of a first geographic region 30 and a second geographic region 50. Of course the master network device 16 and the service center 70 (discussed in detail below) may be in these or in other, remote geographic regions interconnected by communications network 24. For example, the master network device 16 and service desk 70 may be located in one region of the United States, the first geographic region 30 in a different region of the United States, and the second geographic region may encompass one or more countries on a different continent (such as Asia, Europe, South America, and the like). Additionally, the system 10 may be expanded to include additional master network devices 16, service centers 70, and geographic regions 30, 50.

As illustrated, the first geographic region 30 includes a client network device 36 linked to the communications network by link 32 and an intermediate server 38 linked to the communications network 24 by link 34. This arrangement allows the software distribution tool 18 to distribute the application package to the client network device 36 (e.g., an end user server or end user device) and to the intermediate server 38 which in turn distributes the application package to the client network devices 42 and 46 over links 40 and 44. If problems arise during distribution or operations, a first maintenance center 48 is provided in the first geographic region 30 to provide service and is communicatively linked with link 47 to the communications network 24 to receive maintenance instructions from the service center 70 (i.e., electronic job tickets), as will be discussed in detail. Similarly, the second geographic region 50 comprises a second maintenance center 68 communicatively linked via link 67 to the communications network 24 for servicing the devices in the region 50. As illustrated, an intermediate server 54 is linked via link 52 to the communications network 24 to receive the distributed packages and route the packages as appropriate over link 56 to intermediate server 58, which distributes the packages over links 60 and 64 to client network devices 62 and 66.

Many problems may arise during distribution of software packages by the software distribution tool 18. An error, failure, or fault may occur due to communication or connection problems within the communications network 24 or on any of the communication links (which themselves may include a data communications network such as the Internet), and these errors are often labeled as connection errors. An error may occur for many other reasons, including a failure at a particular device to install or a failure of a server to distribute, and these errors are sometimes labeled as failed package and access failure errors. Many other errors and failures of package distribution will be apparent to those skilled in the art, and the system 10 is typically configured to track and process each of these errors.

Preferably, the software distribution tool 18 and/or the intermediate servers and client network devices are configured to create and transmit error alerts upon detection of a distribution error or fault (such as failure to complete the distribution and installation of the package). Typically, the intermediate servers immediately upstream of the affected device (server or end user device) are adapted to generate an error alert, e.g., an e-mail message, comprising information relevant to the package, the location of the problem, details on the problem, and other information. The error alert is then transmitted to the master network device 16, which in turn transmits the error alert to the service center 70 for processing and response. Alternatively, the error alert may be transmitted directly to the service center 70 for processing with the auto ticket tool 72. For example, the software distribution tool 18 may initiate distribution of a package to the client network device 46 but an error may be encountered that prevents installation. In response, the intermediate server 38 generates an error alert to the master network device 16 providing detailed information pertaining to the problem. In some situations, the intermediate server 38 may attempt connection and distribution to the client network device 46 a number of times, which may result in a number of error alerts being issued for a single problem and single network device 46.

Significantly, the service support system 10 includes the auto ticket tool 72 within the service center 70 to process the created error alerts to efficiently make use of resources at the maintenance centers 48, 68. In practice, the auto ticket tool 72 may comprise a software program or one or more application modules installed on a computer or computer system, which may be part of the service center 70 or maintained at a separate location in communication with the service center 70. The error alerts generated by the various server and client network devices are routed to the service center 70 over the communications network 24 via link 69 directly from the servers and client network devices or from the software distribution tool 18. As discussed previously, the error alerts may take a number of forms, and in one embodiment, comprise digital data contained in an e-mail message that is addressed and routed to the network address of the service center 70.

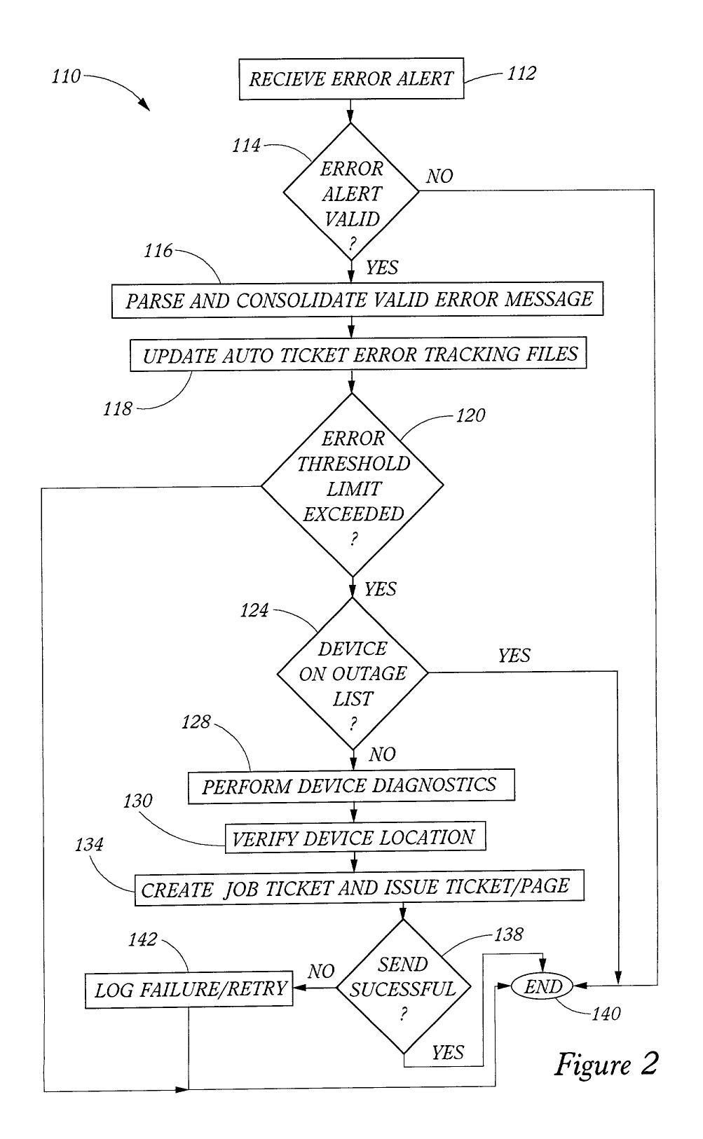

According to an important aspect of the auto ticket tool 72, the tool 72 is configured to process the received error alerts automatically to validate the error alerts based on their source and other criteria. In this regard, as will be discussed with reference to FIG. 2, the service center 70 includes memory 74 comprising a domain list 76 and a node list 78. These lists 76, 78 can be used in conjunction or separately by the auto ticket tool 72 to verify that the error alert originated from an appropriate source, e.g., a device within the network serviced by the system 10 and/or a device on the distribution list used by the master network device. The lists 76, 78 are preferably created and updated by the auto ticket tool 72 based on data received or retrieved from the software distribution tool 18 to improve the accurateness and currentness of the information in the lists 76, 78.

The memory 74 further includes error alert files 80 for use by the auto ticket tool 72 in storing information from the error alerts. Preferably, the information stored is parsed from the valid error alerts to include a smaller subset of the information in the error alerts that is useful for tracking and processing the error alerts and for creating job tickets. The memory 74 may further include failed distribution files 82 for storing information on which packages were not properly distributed, which devices did not receive particular packages, and the like to allow later redistribution of these packages to proper recipient network devices.

The memory 74 further includes a file 75 containing the threshold limits utilized by the auto ticket tool 72 in selectively creating and issuing job tickets based on received and processed alerts. Briefly, the threshold limits 75 are a predetermined or user-selectable number of error alerts regarding a particular problem that are to be received before a job ticket will be issued to address the problem. The threshold limits may be set and varied for each type of problem or fault and may even be varied by device, region, or other factors. For example, it may be desirable to only issue a job ticket for a particular device after connection has been attempted four or more times over a selected period of time. In this manner, problems within the communications network 24 or in various data links that result in distribution failing and error alerts being created may not necessarily result in “false” job tickets being issued (e.g., the problem is in the network, such as at an ISP, rather than at the network device). For other errors, it may be desirable to set a lower threshold limit, such as, a threshold limit of one if the problem was a failed installation upon a particular device. It should be noted that the memory 74 and the auto ticket tool 72 may be located on separate devices rather than on a single device as illustrated as long as auto ticket tool 72 is provided access to the information illustrated as part of memory 74 (which may be more than one memory device).

According to another important aspect of the auto ticket tool 72, the tool 72 is configured to determine, once a threshold limit is exceeded (i.e., typically, exceeding a threshold limit means to meet or exceed the set number), whether the problem can be explained by causes that do not require service. For example, network operations often require particular devices to be taken offline to perform maintenance or other services. Often, a network system will include a file or database for posting which network devices are out of service for maintenance. In this regard, the service support system 10 includes a database server 86 linked to the communications network 24 via link 84 having an outage notice files database 88. The auto ticket tool 72 is adapted for performing a look up within the outage notice files 88 to verify that the device is online prior to creating and issuing a job ticket. This outage checking eliminates issuing many unnecessary job tickets which if issued add an extra administrative burden on the maintenance centers 48, 68.

As will become clear from the discussion of the operation of the auto ticket tool 72, further processing may be desirable to further enhance the quality of the issued job tickets. For example, it is preferable that the information included in the job tickets be correct and the job tickets be issued to the appropriate maintenance centers 48, 68. In this regard, the database server 86 may include device location files 90 including location information for each device in the network serviced by the system 10. With this information available, the auto ticket tool 72 preferably functions to perform searches of the device location files 90 with the location and device name information parsed from the error alerts to verify that the location information is correct. The verified location information is then included by the auto ticket tool 72 in created and transmitted job tickets. Of course, the outage notice files 88 and device location files 90 may be stored separately and in nearly any type of device as long as auto ticket tool 72 is provided access to the included information.

The operation of the auto ticket tool 72 within the automated core analysis system 10 will now be discussed in detail with reference to FIGS. 2-4. Referring first to FIG. 2, exemplary features of an automated error alert processing 110 carried out by the auto ticket tool 72 during distribution of software packages (or general operations of the system 10) are illustrated. The error alert processing begins at 112 with the receipt of an error alert 112 by the auto ticket tool 72. As discussed previously, the error alert received at 112 is generally in the form of an e-mail message but the auto ticket tool 72 may readily be adapted to receive error alerts 112 having other formats.

To control the number of erroneous job tickets produced, the processing 110 continues at 114 with validation of the received error alert 114. As can be appreciated, numerous e-mail messages and improper (e.g., not relating to an actual problem) error alerts may be received by the auto ticket tool 72, and an important function of the auto ticket tool 72 is to filter out the irrelevant or garbage messages and alerts. The steps taken by auto ticket tool 72 may be varied significantly to achieve the functionality of identifying proper error alerts that should be acted upon or at least tracked.

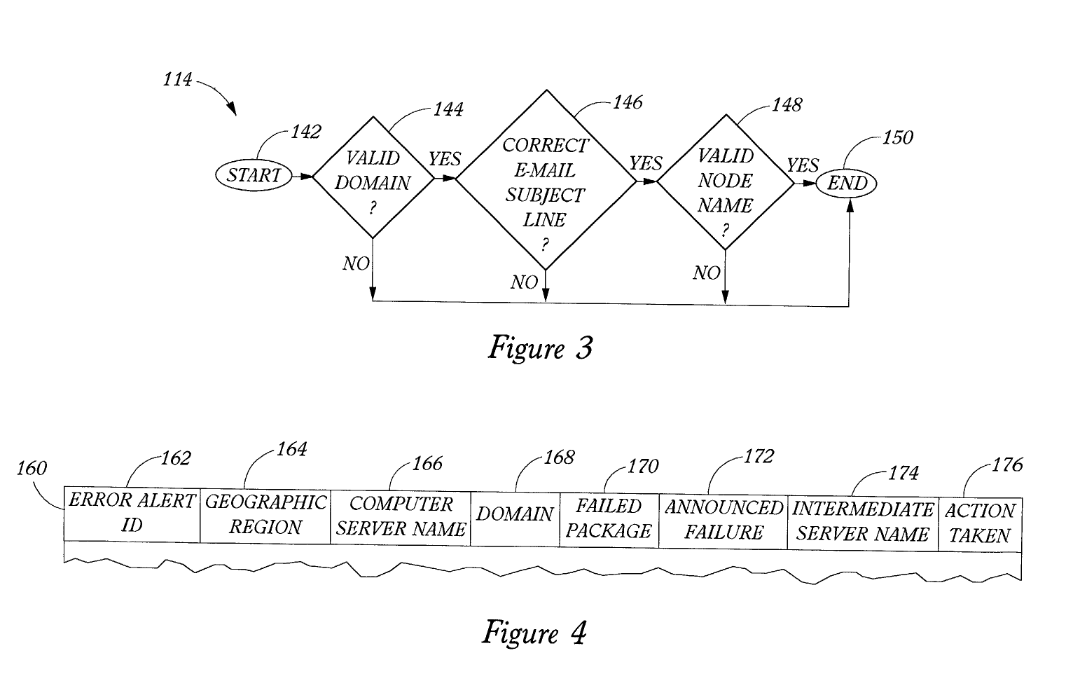

In the embodiment illustrated in FIG. 3, the error alert validation process 114 includes a series of three verification steps. The validation process 114 starts at 142 and proceeds at 144 with the determination of whether the source of the error alert has a valid domain. For an e-mail error alert, this determination involves comparing the domain of the e-mail error alert with domains included in the domain list 76. The domains in the domain list 76 may be the full domain or Internet address or may be a portion of such domain information (e.g., all information after the first period, after the second period, the like). If the e-mail came from a domain serviced by the system 10, the validation process 114 continues at 146 with inspection of the subject line of the e-mail message. If not from a recognized domain, the error alert is determined invalid and processing of the error alert ends at 140 of FIG. 2. Note, the domains in the domain list 76 may be further divided into domains for specific distribution efforts or for specific packages, and the auto ticket tool 72 may narrow the comparison with corresponding information in the error alert.

At 146, validation 114 continues with inspection of the subject line of the error alert in an attempt to eliminate garbage alerts or messages that are not really error alerts. For example, e-mail messages may be transmitted to the auto ticket tool 72 that are related to the distribution or error but are not an error alert (e.g., an end user may attempt to obtain information about the problem by directly contacting the service desk 70). To eliminate these misdirected or inappropriate error alerts, the auto ticket tool 72 in one embodiment functions to look indications of inappropriate error alerts such as “forward” or “reply” in the e-mail subject line. The presence of these words indicates the e-mail error alert is not a valid error alert, and the validation process 114 is ended at 150.

If the subject line of the error alert is found to be satisfactory, the validation 114 continues at 148 with validation of the node name of the device that transmitted the error alert. Typically, the node name is provided as the first part of the network or Internet address. Validation is completed by comparing the node name of the source of the error alert with node names in the node list 78. If the node name is found, the e-mail error alert is validated and processing ends at 150. If not, the error alert is invalidated and auto ticket tool 72 ends processing of the error alert. Again, the node names in the node list 78 may be grouped by distribution effort and/or application packages. In the above manner, the auto ticket tool 72 effectively reduces the number of error alerts used in further processing steps and controls the number of job tickets created and issued.

Referring again to FIG. 2, the error alert processing 110 continues at 116 with the validated error alert. Significantly, the auto ticket tool 72 is adapted to filter the amount of information in each error alert to increase the effectiveness of later tracking of error alerts and distribution problems while retaining information useful for creating accurate job tickets. At 116, the auto ticket tool 72 functions to parse information from the valid error alert for later use in error alert processing 110. As part of the file-updating step 118, the parsed information may be stored in various locations such as a record in the error alert files 80. Additionally, the parsed information may be stored in numerous configurations and may be contained in files related to each network device (e.g., servers and client network devices) or related to specific types of problems.

To illustrate the type of information that may be parsed, but not as a limitation to a particular data structure arrangement, a record 160 that may be provided in the error alert files 80 for each validated and parsed error alert is shown in FIG. 4. As illustrated, the record 160 includes an error alert identification field 162 for containing information useful for tracking particular error alerts. A geographic region field 164 is provided that contains adequate location information to allow the auto ticket tool 72 to sort the error alerts by geographic region. As shown in FIG. 1, the geographic regions 30, 50 are directly related to the location of the maintenance centers 48, 68. Consequently, the geographic region field 164 is included to allow the auto ticket tool 72 to sort the error alerts by maintenance centers 48, 68, which enables job tickets to be transmitted to the maintenance center 48, 68 responsible for servicing the device related to the error alert. In some situation, sorting by geographic region also enables the auto ticket tool 72 to produce reports indicating errors occurring in specific geographic regions which may be utilized to more readily identify specific service problems (such as a network link problem in a specific geographic area).

The error alert record 160 further includes a computer server name field 166 for storing the name of the device upon which installation of the distributed package failed. This information is useful for completion of the job ticket to allow maintenance personnel to locate the device. The device name is also useful for checking if the device has been intentionally taken offline (see step 124). Additionally, in some embodiments of the invention, error alert files 80 may include tracking files or records (not shown) for each device serviced by the system 10. Such records may include a field for each type of problem being tracked by the auto ticket tool 72 for storing a running total of the number of error alerts received for that device related to that specific problem. When the total in any of the problem or error fields for a particular device exceeds (or meets) a corresponding threshold limit 75, auto ticket tool 72 continues the process of verifying whether a job ticket should be created and issued for that device. Use of the threshold limit is discussed in more detail in relation to step 120.

Additional fields that may be included in the record 160 include, but are not limited to, a domain field 168 for the source of the error alert, a failed package field 170 for storing information pertaining to the distributed package, and an announced failure field 172 for storing the initially identified problem. The announced failure field 172 is important for use in tracking the number of error alerts received pertaining to a particular problem (as utilized in step 120) and for inclusion in the created job ticket to allow better service by the maintenance centers 48, 68. An intermediate server name field 174 is included to allow tracking of the source of the error alert. Additionally, an action taken field 176 is provided to track what, if any, corrective actions have been taken in response to the error alert. Initially, the action taken field 176 will indicate no action because this information is not part of the parsed information from the error alert.

The error alert process 110 at 118 involves updating error ticket tracking files maintained by the auto ticket tool 72. As noted, these files may include database records of each error alert and preferably include a record for each device serviced by the system 10 for which errors may arise. Hence, updating 118 may involve storing all of the parsed information in records, such as record 160, and may include updating the record of the affected network device. For example, the record for the affected network device may be updated to include a new total of a particular error for later use in the processing 110.

At 120, the auto ticket tool 72 acts to determine if an error threshold limit has been exceeded after the receipt and addition of the validated error alert to the tracking files. If a threshold is not exceeded, processing 110 is ended at 140, but when a threshold is exceeded, processing 110 continues at 124 to determine if a job ticket should be issued. As discussed above, the threshold limits 75 are set for each type of problem anticipated during distribution of a package by the software distribution tool. The limits may be initially set for the entire network, be set for parts of the network (and even particular devices within the network), and preferably, may be later adjusted by an operator of the service center 70 to allow adaptation of the system 10 to changing network and equipment conditions. At 120, auto ticket tool 72 may function to determine if a threshold has been exceeded in a number of acceptable ways.

For example, the parsed information in field 172 of record 160 for the error alert may be used to obtain the announced failure and this information may be used to total the number of that type of errors that have occurred. In addition, the information in the computer server name field 166 may be used to identify the affected network device and the totaling of the particular type of error may be completed with reference only to that particular, affected device. Alternatively, auto ticket tool 72 may function to look up the device named in field 166 (or in the error alert) to determine if any of its error totals now exceed the applicable threshold from threshold limits 75. Clearly, other threshold verification techniques and tracking may be employed as part of the invention.

If a threshold is exceeded, processing 110 continues at 124 with the auto ticket tool 72 operating to determine if the affected network device (i.e., the device indicated on the most recent error alert) has been placed out of service or offline for maintenance (typically, maintenance unrelated to the distribution of the package). In the illustrated embodiment of the system 10, the auto ticket tool 72 performs a look up for the affected device by name or by other identifying information in the outage notice files 88, which are preferably updated by the maintenance centers 48, 68 and network operators to indicate when particular devices are out of service or offline. If the affected device is found in the outage notice files 88, processing is ended at 140. Additionally, in some embodiments, the auto ticket tool 72 then acts to update the tracking files 80 to remove the error alert from the databases such that running totals of errors are not affected by information in this error alert.

If the affected device is not on an outage listing, the auto ticket tool 72 continues processing 110 at 128 by running a series of diagnostics on the affected device. These diagnostics are utilized to identify network problems that indicate whether the problem lies with the device or within the network itself. For example, Packet Internet Groper (PING) may be run to test whether the device is online. Additionally or alternatively, the diagnostics may include running Traceroute software to analyze the network connections. The diagnostic information obtained in step 128 preferably is included in the job ticket issued on the affected device to assist in addressing the problem. Alternatively, certain diagnostic results may indicate that a job ticket should not yet be issued for the device and the processing 110 may be ended at 140 without creation of a job ticket (which may also indicate that error-tracking databases should be updated).

After performing device diagnostics, the auto ticket tool 72 operates at 130 to verify the accuracy of at least some of the information parsed from the error alert prior to creation of the job ticket. Specifically, auto ticket tool 72 operates to cross check the name and/or network address of the device and the location provided in the error alert with the location and device name and/or network address provided in the device location files 90, which are maintained by system administrators indicating the location (i.e., building and room location of each device connected to the network serviced by the system 10). The device name often will comprise the MAC address and the IP address to provide a unique name for the device within the network. If the name is matched but the location information is not matched, the auto ticket tool 72 may function to retrieve the correct location information from the device location files and place this in the error alert files 80 for this particular device.

At 134, the auto ticket tool 72 creates a job ticket and issues the job ticket to the appropriate maintenance center 48, 68. The information included in the job ticket may be varied but typically will at least include the name of the affected device, the announced failure, the number of error alerts (e.g., the threshold limit or one over the threshold limit), the time and date of the error alerts, diagnostic information, the package being distributed, and the location of the device. The job tickets in one embodiment are created in e-mail form from an electronic template maintained by the auto ticket tool 72 or another device (not shown). The auto ticket tool 72 automatically retrieves the appropriate information for the template fields from the error alert tracking files 80 or as gathered in previous steps of the processing 110 and fills in the fields of the job ticket template.

The completed job ticket is then transmitted via link 69 and the communications network 24 to the appropriate maintenance center 48, 68 based on parsed geographic region information and/or verified location information. The transmittal of the job ticket may be completed immediately upon completion of the template or the ticket may be held for periodical transmittal (such as once a shift or once a day, week, and the like) for each device, for select locations (certain buildings), and/or for each maintenance center 48, 68. Instead of transmitting the job tickets to a central maintenance center 48, 68, the job tickets may be routed to a service desk queue on a network device located in the same building where the affected network device is positioned. If a building does not have service personnel, the job ticket would be routed to a nearby building which houses service personnel and this location information is included in the error alert files 80.

Additionally, in some embodiments, the job ticket is later modified to include information based on other error alerts. For example, the job ticket may be held by the auto ticket tool 72 for a predetermined period of time (e.g., until the end of a work shift or calendar day) and other job created job tickets added or combined with the initially created job ticket. In this manner, the number of job tickets issued for each device or to each maintenance center is further managed by the auto ticket tool 72.

At 138, auto ticket tool 72 operates to verify that the job ticket was successfully transmitted to the addressee maintenance center 48, 68. If successful, the processing ends at 140 and the auto ticket log 72 waits for receipt of the next error alert. If the transmittal was not successful, the auto ticket tool 72 logs the failure and preferably is adapted to retry transmittal one or more times. For example, each job ticket may be transmitted four times prior to logging failure and ending the processing 110 at 140. The first retry may be immediate and each successive retry attempted after a given period of time (e.g., after 30 seconds, after 5 minutes, after 1 hour, and the like) to allow problems in the network to be corrected.

In one embodiment of the invention, the auto ticket tool 72 is further adapted to determine whether a maintenance personnel associated with the maintenance centers 48, 68 should be directly contacted (e.g., paged, e-mailed with the job ticket, or otherwise alerted to the problem). To achieve this function, a record may be kept in memory 74 for each device with information as to whether a page or immediate alert is appropriate for that device. The paging information may be more specific to request a page be transmitted when specific problems at a device exceed the threshold limit. Preferably, the paging information includes an on and off setting to enable an operator of the service center 70 to readily switch each device's paging settings.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the auto ticket tool 72 may readily be utilized with multiple software distribution tools 18 and a more complex network than shown in FIG. 1 that may include more geographic regions and intermediate servers and client network devices and combinations thereof. Similarly, the descriptive information and/or strings collected from the error alerts and included in the created job tickets may also be varied.

We claim:

1. A computer service method for selectively creating job tickets in response to error alerts, the error alerts being created during package distribution on a computer network comprising a plurality of network devices and including information related to package distribution failure, the method comprising:
receiving an error alert;
processing the error alert to identify a failure type from the failure information;
updating an error tracking file comprising tracking values for each of the failure types to incrementally change a tracking number for the identified failure type;
comparing the updated tracking value for the identified failure type to a threshold limit for the identified failure type to determine if the threshold limit is exceeded; and
when the comparing determines the threshold limit is exceeded, creating a job ticket including at least a portion of the failure information from the error alert to initiate service in the computer network.

2. The method of claim 1, wherein the threshold limits are predetermined and stored in memory accessible during the comparing and wherein the threshold limits are selected to differ for at least some of the failure types.

3. The method of claim 2, further including modifying the threshold limits in memory, the modifying being completed manually or automatically.

4. The method of claim 1, wherein the error alert processing further includes retrieving identification data on a network device affected by the package distribution failure, the method further includes determining with the identification data whether the affected network device is included on an outage list, and further wherein the job ticket creating is not completed when the affected network device is determined to be included on the outage list.

5. The method of claim 1, wherein the error alert processing further includes retrieving identification data on a network device affected by the package distribution failure and further wherein the tracking values for each of the failure types are included in the error tracking file for each of the network devices.

6. The method of claim 5, wherein the threshold limits are selectable for each of the network devices.

7. The method of claim 1, wherein the error alert processing further includes retrieving location information for a network device affected by the package distribution failure for use in the job ticket creating, and further wherein the method includes matching the retrieved location information with device location information stored in memory and when a match is not achieved, modifying the retrieved location information to match the device location information.

8. The method of claim 1, further including processing the error alert to retrieve location information for the network device affected by the package distribution failure, determining a job ticket recipient from a set of network maintenance centers based on the location information, and transmitting the created job ticket to the job ticket recipient.

9. The method of claim 8, wherein the job ticket is an e-mail message and the transmitting uses a data communications network, and further wherein the transmitting comprises verifying whether the transmitting was completed and if not successful, repeating the transmitting a predetermined retry value.

10. A method for automatically responding to error alerts created by network devices during operation of a computer network, comprising:
providing a network device file comprising identification information for each of the network devices in the computer network;
receiving an error alert comprising failure information related to a network failure and to at least one of the network devices affected by the network failure;
validating the received error alert as being transmitted by one of the network devices by comparing the failure information in the received error alert related to the one network device with the identification information in the network device file; and
if the received error alert is validated, creating a job ticket for the one network device including at least a portion of the failure information for use in servicing the one network device.

11. The method of claim 10, wherein the identification information includes a domain for each of the network devices and wherein the validating includes comparing a domain included in the failure information of the error alert with the domain in the identification information for the one network device.

12. The method of claim 10, wherein the identification information includes a node name for each of the network devices and wherein the validating includes comparing a node identification included in the failure information of the error alert with the node name in the identification information for the one network device.

13. The method of claim 10, wherein the error alert is an e-mail message transmitted by one of the network devices and wherein the validating includes inspecting the subject line of the error alert for non-valid subject terms.

14. The method of claim 13, wherein the non-valid subject terms include forward and reply.

15. The method of claim 10, further including parsing the error alert to filter out error tracking information and the portion of the failure information included in the job ticket.

16. The method of claim 15, wherein the portion of the failure information includes geographic location information for the one network device, and wherein the method further includes identifying a maintenance center associated with the one network device based on the geographic location information.

17. The method of claim 16, further including electronically transmitting the created job ticket to the identified maintenance center.

18. The method of claim 17, wherein the maintenance center identifying includes determining a member of a service group associated with the identified maintenance center and responsible for servicing the one network device and wherein the electronically transmitting includes directly notifying the service group member.

19. The method of claim 15, wherein the error tracking information includes an error type and wherein the method includes updating a corresponding tracking value in an error tracking file to incrementally change the tracking value and includes comparing the changed tracking value to a threshold limit for the error type to determine if the job ticket creating should be completed.

20. The method of claim 10, further including prior to the job ticket creating, performing diagnostics for the one network device to obtain diagnostic information and verifying location information in the failure information to obtain verified location information, and wherein the job ticket creating includes the diagnostic information and the verified location information.

21. A computer program product for processing error alerts created for a computer network to determine when to create job tickets to address errors identified in the error alerts, comprising:
first computer code devices configured to cause a computer to process a received error alert to identify a failure type from failure information included in the received error alert and to identify a source of the received error alert;
second computer code devices configured to cause a computer to validate the received error alert by accessing a network file including identification information for each network device in the computer network and determining whether the source of the received error alert is included in the network file;
third computer code devices configured to cause a computer to, after the error alert is validated, update an error tracking value for the identified failure type and to compare the updated error tracking value with a threshold limit for the identified failure type; and
fourth computer code devices configured to cause a computer to, when the threshold limit is exceeded, create a job ticket in response to the validated error alert comprising at least a portion of the failure information.

22. The computer program product of claim 21, wherein the first computer code device is further configured to process the received error alert to obtain identification information on the affected one of the network devices from the failure information and further including fifth computer code devices configured to cause a computer to access a device outage list in memory to use the identification information to determine if the affected network device is on the outage list.

23. The computer program product of claim 21, further including fifth computer code devices configured to cause a computer to verify and if not verified, correct at least a portion of the failure information included in the job ticket.

24. A service support system for at least partially automatically processing error alerts created in a distributed computer network in response to a failure during distribution of a software package to network devices and for selectively creating and issuing job tickets to correct the failure, comprising:
a memory device including files for storing identification data for each of the network devices in the computer network, for storing threshold limits for previously identified network failure types, and for storing tracking information for each of the failure types indicating a number of the error alerts received relating to each of the failure types; and
an auto ticket tool in communication with the network devices to receive the error alerts and with the memory device to access the identification data and the threshold limits, wherein the auto ticket tool is configured to process each of the error alerts, to determine the failure type, to update the tracking information for the failure type, to determine if the threshold limit for the failure type is exceeded based on the updated tracking information, and if the threshold limit is determined to be exceeded, creating a job ticket for a network device identified by the identification data.

25. The system of claim 24, wherein auto ticket tool is further configured to determine a recipient network device for the job ticket based on location information included in the error alert and to electronically transmit the job ticket to the recipient network device.

26. The system of claim 24, wherein the memory device is further adapted for storing an outage listing comprising identification information for each of the network devices that are being serviced and wherein the auto ticket tool is further operable to prior to only create the job ticket after determining the identified network device is not on the outage listing.

27. The system of claim 24, wherein the memory device is further adapted for storing a device location information comprising a geographic location for each of the network devices and wherein the auto ticket tool is further operable to compare location information included in the error alert with the geographic location information in the device location information and to modify the included location information for use in creating the job ticket.
